(19) United States
(12) Patent Application Publication
(10) Pub. No.: US 2009/0070835 A1
(43) Pub. Date: Mar. 12, 2009

(54) Method and System for Retrieving a Media File

(75) Inventor: Ray Bontempi, Jamison, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/959,549

(22) Filed: Dec. 19, 2007

Related U.S. Application Data
(60) Provisional application No. 60/970,768, filed on Sep. 7, 2007.

(51) Int. Cl. H04N 7/173

(52) U.S. Cl. 725/92

(57) ABSTRACT

A method and apparatus for retrieving media files from a customer premise device are disclosed. For example, the method receives a request from a subscriber to access a media file, and verifies the media file is stored on a customer premise device. The method provides the media file via a communication network to the subscriber if the media file is verified as being stored in the customer premise device.

This application claims the benefit of U.S. Provisional application No. 60/970,768 filed on Sep. 7, 2007, herein incorporated by reference in its entirety.

### FIELD OF THE INVENTION

The present invention relates generally to retrieval of media files.

### BACKGROUND OF THE INVENTION

Currently, subscribers to cable television enjoy the benefits of utilizing digital video recorders issued by the subscriber's cable television company. Digital video recorders provide the ability for subscribers to record various media files such as, for example, television programs and movies for later viewing.

However, the drawback to digital video recorders is that it may be difficult for a subscriber to access media files stored on his digital video recorder when the subscriber is away from home. Bandwidth on upstream communications paths are usually much lower than bandwidth on downstream communications paths making it difficult for the subscriber's digital video recorder to upload media files that may be very large in size to a subscriber's receiving media device. Furthermore, content owners may prohibit cable television companies from allowing their users to freely access multiple copies of the same media files.

### SUMMARY OF THE INVENTION

In one embodiment, the present invention discloses a method, computer readable medium and apparatus for retrieving media files from a customer premise device. For example, the method receives a request from a subscriber to access a media file, and verifies the media file is stored on a customer premise device. The method provides the media file via a communication network to the subscriber if the media file is verified as being stored in the customer premise device.

In another illustrative embodiment, the present invention discloses a computer readable medium having stored thereon a plurality of instructions, the plurality of instructions including instructions which, when executed by a processor, cause the processor to perform the steps of a method for retrieving a media file. When executed, the method receives a request from a subscriber to access a media file, and verifies the media file is stored on a customer premise device. The method provides the media file via a communication network to the subscriber if the media file is verified as being stored in the customer premise device

In another illustrative embodiment, the present invention discloses an apparatus for retrieving a media file. For example, the apparatus comprises a media file database, and a streaming server for receiving a request from a subscriber to access a media file, for verifying said media file is stored on a customer premise device, and for providing said media file retrieved from said media file database to said subscriber.

In another illustrative embodiment, the present invention discloses a method for requesting a media file. For example, the method connects to a cable head end via an access network and requests a media file. The method receives a verification that the requested media file is stored on a customer premise device, and receives the requested media file via the access network.

### BRIEF DESCRIPTION OF THE DRAWINGS

The teaching of the present invention can be readily understood by considering the following detailed description in conjunction with the accompanying drawings, in which:

FIG. 1 illustrates a high level block diagram of an illustrative network architecture of the present invention;

FIG. 2 illustrates an illustrative flow diagram depicting a method for retrieving a media file for a subscriber;

FIG. 3 illustrates an illustrative flow diagram depicting an alternate embodiment of a method for retrieving a media file for a subscriber; and

FIG. 4 illustrates a high level block diagram of an illustrative general purpose computer suitable for use in performing the functions described herein.

To facilitate understanding, identical reference numerals have been used, where possible, to designate identical elements that are common to the figures.

### DETAILED DESCRIPTION

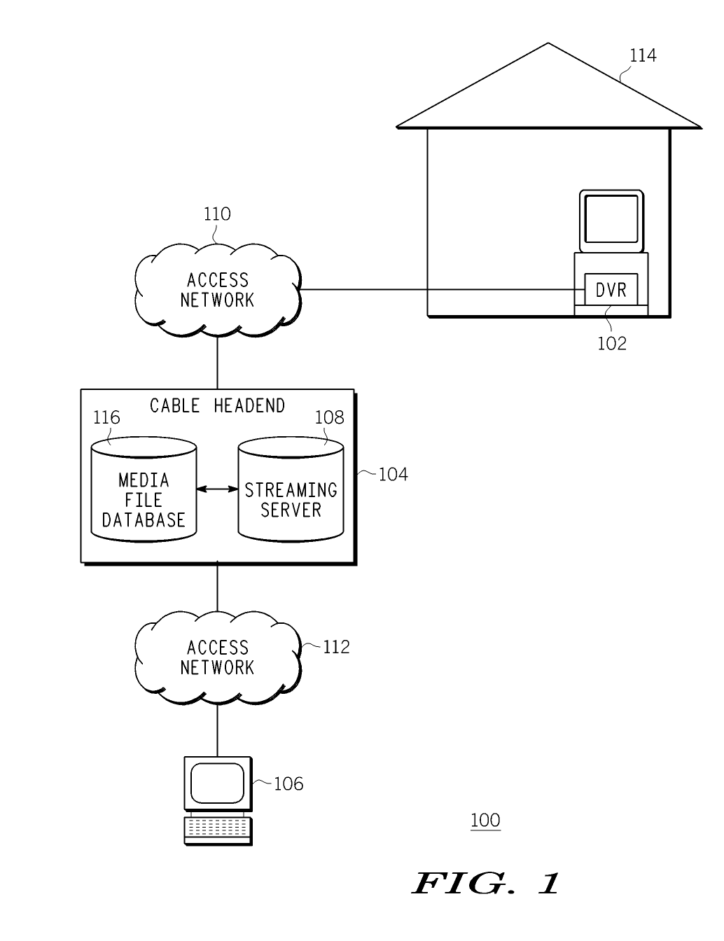

FIG. 1 illustrates a high level block diagram of an illustrative network architecture 100 of the present invention. In one embodiment, network architecture 100 includes a cable headend 104 connected to a subscriber's home 114 via an access network 110 (e.g. a service provider access network). In addition, the cable headend 104 is also able to communicate with a subscriber's media device 106 via an access network 112 (e.g. a service provider access network). Those skilled in the art will recognize that media device 106 may be any type of media device capable of rendering media such as, for example, wireless mobile devices including a laptop computer, a personal digital assistant (PDA), a cellular telephone, a personal digital video player or wired devices including a desktop personal computer, and the like.

It should be noted that access network 110 may be any type of access network 110 for providing television programming, media or data to a subscriber's home 114. Access network 110 may have two-way communication capability via a downstream communications path and an upstream communications path. The upstream communications path may be in-band or out-of-band. Moreover, any communications protocol may be utilized by the access network 110 such as, for example, quadrature amplitude modulation (QAM), data over cable services interface specification (DOCSIS) format on a cable modem termination system (CMTS), gigabit passive optical networks (GPON) and the like.

It should be noted that access network 112 may be any type of data communications network including, but not limited to an Internet, a local area network (LAN), a wide area network (WAN), an ATM network, a wireless network and the like. The access network 112 may also provide two-way communications between the cable headend 104 and the media device 106. Moreover, the access network 112 may be accessed either by a wired connection or a wireless connection. In one embodiment, both access network 110 and 112 may be a service provider access network that are collectively part of a service provider communication network.

The subscriber's home 114 may include a customer premise device 102 (e.g., broadly a remote device) located remotely from the media device 106. Those skilled in the art may recognize that the customer premise device 102 may comprise a digital video recorder issued by the cable service provider or an independent digital video recorder issued by a third party. The customer premise device 102 may be connected to and in communication with the access network 110 via a wired connection or a wireless connection.

The cable headend 104 may be located at a cable service provider. In one embodiment, the cable headend 104 may include a streaming server 108 and a media file database 116. It should be noted that cable headend 104 may include additional hardware and software for delivering media files to a subscriber's home 114 that are not illustrated in FIG. 1. The media file database 116 may record or store in memory all the available media files that may be provided to the subscribers via access network 110. Although the media file database 116 is illustrated as being external to said streaming server 108, the present invention is not so limited. Namely, the media file database 116 can be implemented as being internal or external to the streaming server 108.

With the customer premise device 102, a subscriber to cable television services may record media files delivered to the subscriber's home 114 by the cable headend 104. The customer premise device 102 allows a subscriber to advantageously store media files such that the subscriber may view a desired media file whenever it is convenient for the subscriber, i.e. time-shift viewing of the media files.

However, a subscriber may wish to watch a stored media file when the subscriber is located away from their home 114. For example, a subscriber may be traveling and wish to watch a particular media file on his media device 106 at an airport. Typically, accessing the customer premise device 102 directly via the media device 106 is an inefficient method of downloading a desired media file due to the typical large size of the media files and other communication bandwidth constraints. Furthermore, a subscriber may not have time to wait for the download from the customer premise device 102 to the media device 106.

In addition, the media file would have to be transcoded from a TV format (e.g. High Definition MPEG-2) to a format compatible with a mobile device. The customer premise device 102 may not have the processing capability or processing speed to accomplish the transcoding effectively. In one embodiment, the present invention provides a more efficient method and apparatus for retrieving media files from the customer premise device 102.

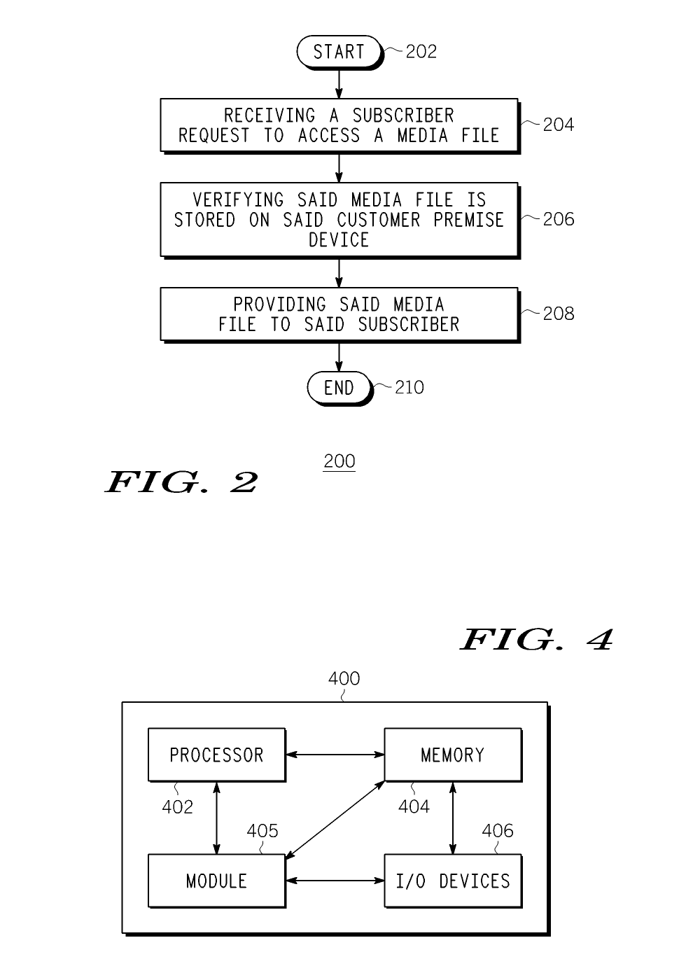

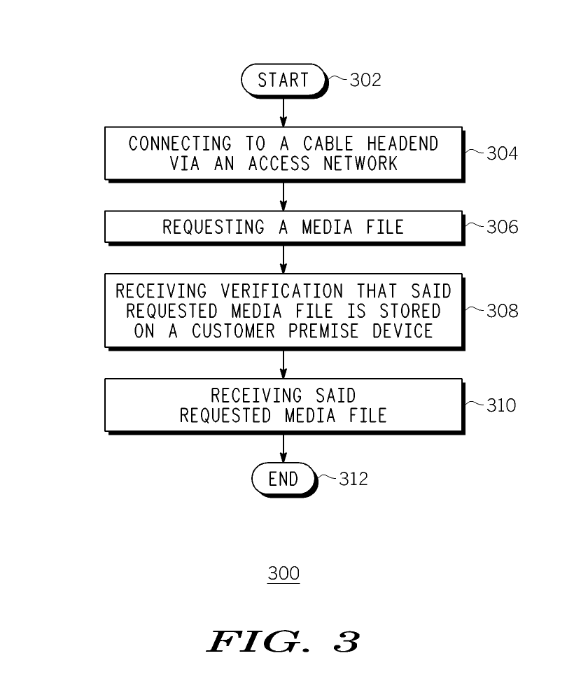

In one embodiment of the present invention, the subscriber may access a stored media file in the customer premise device 102 by communicating with the service provider communication network via the media device 106. For example the media files may include television programs, movies, pay-per-view events, video on demand, digital music and the like that the subscriber has stored in the customer premise device 102. In one embodiment, the streaming server 108 receives requests for a media file from a subscriber, verify the media file is stored on the subscriber's customer premise device 102 and provide the requested media file to the subscriber as will be discussed in further detail below with reference to FIGS. 2 and 3.

FIG. 2 depicts an illustrative flow diagram depicting a method 200 for retrieving media files for a subscriber. For example, the method can be implemented in streaming server 108. The method 200 starts at step 202.

At step 204, the method begins by receiving a subscriber request to access a stored media file. For example, the request to access a media file is received by the streaming server 108 located at the cable headend 104. In addition, before the subscriber is allowed to request access to a stored media file, the subscriber need to be verified. For example, the subscriber may be required to provide a user name and password to connect to the access network 112.

Moreover, the subscriber's request to access a stored media file is generated by the subscriber's media device 106. The media device 106 may transmit the subscriber's request to the cable headend 104 via a connection to access network 112. The subscriber's media device 106 may also be located remotely or physically away from the subscriber's home 114 and the customer premise device 102.

In another embodiment, the subscriber's media device 106 may actually be located in the subscriber's home 114, but just physically away from the customer premise device 102. For example, the subscriber may wish to watch a media file while in his upstairs bedroom, but the customer premise device 102 having the stored media file may be downstairs.

At step 206, the method verifies that the media file is stored on a customer premise device 102. This step ensures that a requesting subscriber is authorized to receive a particular stored media file. In other words, the subscriber must have already recorded the media file on the customer premise device 102 located at the subscriber's home 114. As a result, this step helps to ensure that the requested media file has in fact been stored in the subscriber's DVR.

In one embodiment, the streaming server 108 may perform the verification. For example, the streaming server 108 may obtain a stored media file list from the customer premise device 102. This streaming server 108 may obtain the stored media file list via the access network 110. The stored media file list may contain a dynamic list of all the media files currently stored on the customer premise device 102. For example, the stored media file list may be dynamic because the stored media file list may change as the content stored on the customer premise device 102 changes.

It should be noted that different verification processes can be employed in step 206. For example, the streaming server 108 may communicate with customer premise device 102 to determine what media streams are currently stored in its memory. For example, each stored media stream may have a unique identification that is returned as a response to the streaming server 108. Thus, the streaming server 108 may associate a unique identification with each media file. For example, each television program may have associated with it a unique identification of various numbers or codes (e.g., alphanumeric characters and the like). It should be noted that any method of uniquely identifying each media file may be used. A list of all the unique identifications for all media files may be stored at the cable headend 104 and accessed by the streaming server 108.

Subsequently, the streaming server 108 determines if the requested media file is in the stored media file list of the customer premise device 102. If the requested media file is in the stored media file list, then the streaming server 108 will determine that the subscriber is authorized to access the stored media file. If the media file is not stored in the media file list, then the streaming server 108 will determine that the subscriber is not authorized to access the requested media file and returns an unauthorized access notification message to the subscriber's media device 106.

In step 208, if the streaming server 108 determines that the subscriber is authorized to access the requested media file, then the method proceeds by providing the requested media file to the subscriber. In one embodiment, the streaming server 108 locates the media file in the media file database 116 and delivers the media file to subscriber's media device 106. The media file can be provided to the subscriber's media device either via a wired or a wireless connection to access network 112. It should be noted that the requested media stream is not retrieved from the customer premise 102. Instead, the media stream is retrieved from the file database 116. Since the streaming server has access to the requested media stream locally, it does not need to retrieve that media stream from the customer premise device 102.

In one embodiment, the requested media file is provided to the subscriber via real time streaming. In addition, the subscriber will not be able to permanently store the media file in the memory on the subscriber's media device 106. This prevents the subscriber from making additional copies of the media file, thereby effectively only allowing the subscriber to access what he has stored in the customer premise device 102. Essentially, the subscriber is only receiving authorized access to stored media files that the subscriber would be authorized to watch if the subscriber were at home 114 watching the media file directly off of the customer premise device 102. Moreover, the present invention provides a more efficient method of providing the media file to the subscriber's media device 106 because it utilizes the large amount of bandwidth that is associated with the downstream communications path from the cable headend 104.

In one embodiment, the streaming server 104, while providing the media file to the subscriber's media device 106, may send a command to the customer premise device 102 to prevent the requested video content from being accessed via the customer premise device 102. This prevents the subscriber from freely accessing the subscriber's recorded media files on the customer premise device 102, while the requested media file is being forwarded to the subscriber's media device 106. In other words, this approach will prohibit a subscriber from viewing the requested media file on the media device, while another party is viewing the same media file via the customer premise device 102.

For example, one method of preventing the subscriber's customer premise device from accessing one of the stored media files can be implemented via use of security tokens. For example, a security token can be associated with each of the stored media files in the customer premise device. As long as the security token is detected, then a media file can be accessed by the customer premise device. However, if the security token is missing, e.g., removed in response to a command received from the streaming server, then that particular media stream will not be accessible to be presented by the customer premise device 102 during the duration that particular media stream is being streamed to the subscriber's media device 106. The method then concludes at step 210.

FIG. 3 provides an illustrative flow diagram of an alternate embodiment depicting a method 300 for retrieving stored media files for a subscriber. For example, method 300 can be implemented in media device 106. Method 300 begins at step 302 where a subscriber connects to a cable head end via an access network 112. In addition, the subscriber may access the cable service provider network via media device 106 either via a wired connection or a wireless connection.

In step 304, a subscriber may request a stored media stream. In one embodiment, once the subscriber is authorized to connect to cable head end, for example by entering a user name and password, the user may request and receive a list of stored media files on the customer premise device 102 located at the subscriber's home 114. For example, the list of stored media files is provided by the streaming server 108. Then the subscriber may request a particular media file selected from the list of stored media files. Alternatively, the subscriber may simply be prompted to enter a desired media file name or identification that the subscriber believes is stored on the customer premise device 102.

At step 308, the subscriber receives a verification that the requested media file is stored on the customer premise device 102. As discussed above, the streaming server 108 may perform the verification. For example, the streaming server 108 may obtain a stored media file list from the customer premise device 102 via access network 112, obtain a unique identification of the requested media file and determine if the requested media file is on the stored media file list.

At step 310, if verification is received and the subscriber is authorized to access the requested media file, then the subscriber receives the requested media file via access network 112. As discussed in method 200 above, the streaming server 108 locates the requested media file in media file database 116 and downloads the requested media file to the subscriber's media device 106. Furthermore, the requested media file can be provided via a wired connection or a wireless connection.

As discussed above, while the requested media file is being provided to the subscriber's media device 106, the streaming server 108 may send a command to the customer premise device 102 to prevent the same video content from being accessed via the customer premise device 102. This will prevent the subscriber from freely providing access to the subscriber's recorded media files on the customer premise device 102 to other non-subscribers or subscribers who have not recorded the same media files. Then the method concludes at step 312.

It should be noted that although not specified, one or more steps of methods 200 and 300 may include a storing, displaying and/or outputting step as required for a particular application. In other words, any data, records, fields, and/or intermediate results discussed in the method can be stored, displayed and/or outputted to another device as required for a particular application. Furthermore, steps or blocks in FIGS. 2 and 3 that recite a determining operation or involve a decision do not necessarily require that both branches of the determining operation be practiced. In other words, one of the branches of the determining operation can be deemed as an optional step.

FIG. 4 illustrates a high level block diagram of an illustrative general purpose computer suitable for use in performing the functions described herein. The general purpose computer 400 may be a part of the cable headend 104. As depicted in FIG. 4, the general purpose computer 400 comprises a processor element 402 (e.g., a CPU), a memory 404, e.g., random access memory (RAM) and/or read only memory (ROM), a module 405 for retrieving media files, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the processes provided by the present module 405 for retrieving media files can be loaded into memory 404 and executed by processor 402 to implement the functions as discussed above. As such, the processes provided by the module 405 for retrieving media files of the present invention can be stored on a computer readable medium or carrier, e.g., RAM memory, magnetic or optical drive or diskette and the like.

While the foregoing is directed to illustrative embodiments of the present invention, other and further embodiments of the invention may be devised without departing from the basic scope thereof, and the scope thereof is determined by the claims that follow.

What is claimed is:

1. A method for retrieving a media file, comprising:
receiving a request from a subscriber to access a media file;
verifying said media file is stored on a customer premise device; and
providing said media file via a service provider communication network to said subscriber if said media file is verified as being stored in said customer premise device.

2. The method of claim 1, wherein said subscriber request is generated from a media device located remotely from said customer premise device.

3. The method of claim 1, wherein said verifying step comprises:
obtaining a stored media file list from said customer premise device; and
determining if said requested media file is in said stored media file list.

4. The method of claim 1, wherein said providing step comprises:
streaming said media file to a media device of said subscriber from a streaming server located at a cable headend.

5. The method of claim 4, wherein said media file is not permanently stored in said media device.

6. The method of claim 1, further comprising:
sending a command to said customer premise device to prevent said requested media file from being accessed via said customer premise device.

7. The method of claim 1, wherein said customer premise device comprises a digital video recorder.

8. The method of claim 1, wherein said media file is provided over a wired connection or a wireless connection over said service provider communication network.

9. A computer-readable medium having stored thereon a plurality of instructions, said plurality of instructions including instructions which, when executed by a processor, cause said processor to perform said steps of a method for retrieving a media file, comprising:
receiving a request from a subscriber to access a media file;
verifying said media file is stored on a customer premise device; and
providing said media file via a service provider communication network to said subscriber if said media file is verified as being stored in said customer premise device.

10. The computer-readable medium of claim 9, wherein said subscriber request is generated from a media device located remotely from said customer premise device.

11. The computer-readable medium of claim 9, wherein said verifying step comprises:
obtaining a stored media file list from said customer premise device; and
determining if said requested media file is in said stored media file list.

12. The computer-readable medium of claim 9, wherein said providing step comprises:
streaming said media file to a media device of said subscriber from a streaming server located at a cable headend.

13. The computer-readable medium of claim 12, wherein said media file is not permanently stored in said media device.

14. The computer-readable medium of claim 9, further comprising:
sending a command to said customer premise device to prevent said requested media file from being accessed via said customer premise device.

15. The computer-readable medium of claim 9, wherein said customer premise device comprises a digital video recorder.

16. The computer-readable medium of claim 9, wherein said media file is provided over a wired connection or a wireless connection over said service provider communication network.

17. An apparatus for retrieving a media file, comprising:
a media file database; and
a streaming server for receiving a request from a subscriber to access a media file, for verifying said media file is stored on a customer premise device, and for providing said media file retrieved from said media file database to said subscriber via a service provider communication network.

18. The apparatus of claim 17, wherein said subscriber request is generated from a media device located remotely from said customer premise device.

19. The apparatus of claim 17, wherein said verifying comprises:
obtaining a stored media file list from said customer premise device; and
determining if said requested media file is in said stored media file list.

20. The apparatus of claim 17, wherein said providing comprises:
streaming said media file to a media device of said subscriber from said streaming server located at a cable headend.

21. A method for requesting a media file, comprising:
connecting to a cable head end via a service provider access network;
requesting a media file;
receiving a verification that said requested media file is stored on a customer premise device; and
receiving said requested media file via said service provider access network.
